(19) United States
(12) Patent Application Publication
(10) Pub. No.: US 2025/0322176 A1
(43) Pub. Date: Oct. 16, 2025

(54) ARTIFICIAL INTELLIGENCE (AI)-BASED ILLUSTRATED STORY GENERATION SERVICE

(71) Applicant: Microsoft Technology Licensing, LLC, Redmond, WA (US)

(72) Inventors: Farzaneh RAJABI, San Jose, CA (US); Ji LI, San Jose, CA (US)

(73) Assignee: Microsoft Technology Licensing, LLC, Redmond, WA (US)

(21) Appl. No.: 18/799,419

(22) Filed: Aug. 9, 2024

Related U.S. Application Data
(60) Provisional application No. 63/632,353, filed on Apr. 10, 2024.

(51) Int. Cl. G06F 40/40; G06T 11/00; G06T 13/40

(52) U.S. Cl. CPC G06F 40/40; G06T 11/00; G06T 13/40

(57) ABSTRACT

An Artificial Intelligence (AI)-based illustrated story generation system enables stylized character profiles to be generated from user photos and illustrated stories to be generated based on narrative prompts which indicate the character profiles to use in the story. To generate the character profiles, the photos are provided to a character description model trained to generate a description of a character based on the photo. The description is then provided to an image generating model which generates a stylized image of the character based on the description. To generate an illustrated story, a narrative prompt and at least one character profile are provided to a story text generating model which generates text for the story. The story text is then provided to an image generating model page by page which generates an illustration for each page based on the page text.

### BACKGROUND

An illustrated story is a narrative that is accompanied by visual representations, typically in the form of drawings, paintings, or photographs. These visual elements serve to enhance the storytelling experience, providing additional context, depth, and engagement for the reader. In an illustrated story, the images often complement the text, helping to convey emotions, settings, characters, and key plot points. This fusion of words and visuals creates a rich and immersive narrative experience, appealing to both the imagination and the senses. Illustrated stories can range from children's picture books to graphic novels for adults, spanning a diverse array of genres and styles. Current generative models offer promising capabilities in rendering detailed images from textual descriptions. However, they are generally not capable of generating illustrated stories with visually consistent character representations across a sequence of illustrations or generating images capable of showing changes that demonstrate believable character development within the narrative of a story. Furthermore, current systems have limited ability to personalize generated story content or to enable user preferences to guide story creation.

Hence, what is needed are Artificial Intelligence (AI)-based story generating systems capable of generating story text and illustrations that do not suffer from the limitations of the prior art.

### SUMMARY

In one general aspect, the instant disclosure presents a data processing system having a processor and a memory in communication with the processor wherein the memory stores executable instructions that, when executed by the processor alone or in combination with other processors, cause the data processing system to perform multiple functions. The functions include receiving a narrative prompt from a client application that defines one or more story parameters for an illustrated story to be generated by an illustrated story generating system and that identifies at least one character profile to include in the story; retrieving the at least one character profile and providing the narrative prompt and the at least one character profile to a story text generator model trained to generate story text based on the narrative prompt and the at least one character profile, the story text including a plurality of pages, each of the pages having page text; receiving the story text from the story text generator model and providing each page of the story text as a prompt to a page illustration generator model, the page illustration generator model being trained to generate a page illustration for each page based on the story text for the page; and as each page illustration is generated, saving the page illustration and the page text associated with the page illustration as a story page of an illustrated story file.

In yet another general aspect, the instant disclosure presents a method of generating an illustrated story using an illustrated story generating system. The method includes receiving a narrative prompt from a client application that defines one or more story parameters for an illustrated story to be generated by the illustrated story generating system and that identifies at least one character profile to include in the story; retrieving the at least one character profile and providing the narrative prompt and the at least one character profile to a story text generator model trained to generate story text based on the narrative prompt and the at least one character profile, the story text including a plurality of pages, each of the pages having page text; receiving the story text from the story text generator model and providing each page of the story text as a prompt to a page illustration generator model, the page illustration generator model being trained to generate a page illustration for each page based on the story text for the page; and as each page illustration is generated, saving the page illustration and the page text associated with the page illustration as a story page of an illustrated story file.

In a further general aspect, the instant application describes a non-transitory computer readable medium on which are stored instructions that when executed cause a programmable device to perform functions of receiving a narrative prompt from a client application that defines one or more story parameters for an illustrated story to be generated by the illustrated story generating system and that identifies at least one character profile to include in the story; retrieving the at least one character profile and providing the narrative prompt and the at least one character profile to a story text generator model trained to generate story text based on the narrative prompt and the at least one character profile, the story text including a plurality of pages, each of the pages having page text; receiving the story text from the story text generator model and providing each page of the story text as a prompt to a page illustration generator model, the page illustration generator model being trained to generate a page illustration for each page based on the story text for the page; and as each page illustration is generated, saving the page illustration and the page text associated with the page illustration as a story page of an illustrated story file.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 is a diagram showing an example computing environment in which aspects of the disclosure may be implemented.

FIG. 2 shows an example implementation of a character profile generating component of the illustrated story generation service of FIG. 1.

FIG. 3 shows an example implementation of an illustrated story generating component of the story generation system of FIG. 1.

FIG. 4 shows a flowchart of a method of generating character profiles for inclusion in an illustrated story generated by the illustrated story generating system of FIG. 1.

FIG. 5 shows a flowchart of a method of generating an illustrated story using the illustrated story generating system of FIG. 1.

FIG. 6 is a block diagram showing an example software architecture, various portions of which may be used in conjunction with various hardware architectures herein described, which may implement any of the described features.

FIG. 7 is a block diagram showing components of an example machine configured to read instructions from a machine-readable medium and perform any of the features described herein.

### DETAILED DESCRIPTION

Current generative models offer promising capabilities in rendering detailed images from textual descriptions. However, they fall short when tasked with the complexity of generating story illustrations. Such an endeavor involves not just the generation of isolated images but the creation of a visual sequence where characters must exhibit continuity in appearance, personality, and emotion across a sequence of illustrations. Current image generating systems are generally not capable of generating sequences of illustrations that maintain adequate character consistency from image to image. Current systems are also not capable of generating sequences of illustrations for a story that can show believable changes that reflect character development and evolving character relationships within the narrative of the story while also preserving the core visual identity of the characters. The diversity of generated images and the need for interactive flexibility pose further challenges to automated illustrated story generation. Users are generally not able to modify aspects of generated illustrations, such as changing the outfits of characters to fit a desired storyline, without scrapping generated content and starting over.

To address the technical problems associated with enabling interactive and personalized visual storytelling experiences, this description provides technical solutions in the form of an AI assisted story generation system capable of generating personalized story content with stylized illustrations that preserve character identity from image to image and are capable of depicting changes over time to reflect character development within the story while respecting the character's core traits. The system leverages Al including Large Language Models (LLMs), such as DALL-E and Stable Diffusion, to enable a visual storytelling experience that is both immersive and interactive. The system addresses the technical problem that current generative models are inadequate for story visualization and the generation of visual sequences that require consistency of characters, backgrounds, and other elements that align with the user's intent for the story. An aspect includes a user experience (UX) which generates a tangible result in the form of a personalized storybook responsive to user input and interaction for creating and modifying a storyline. Another aspect includes an architecture for creating a personalized storybook that leverages AI and LLMs and includes modules for visual identity consistency, character development over time, character interaction modeling, and interactive storyline adaption.

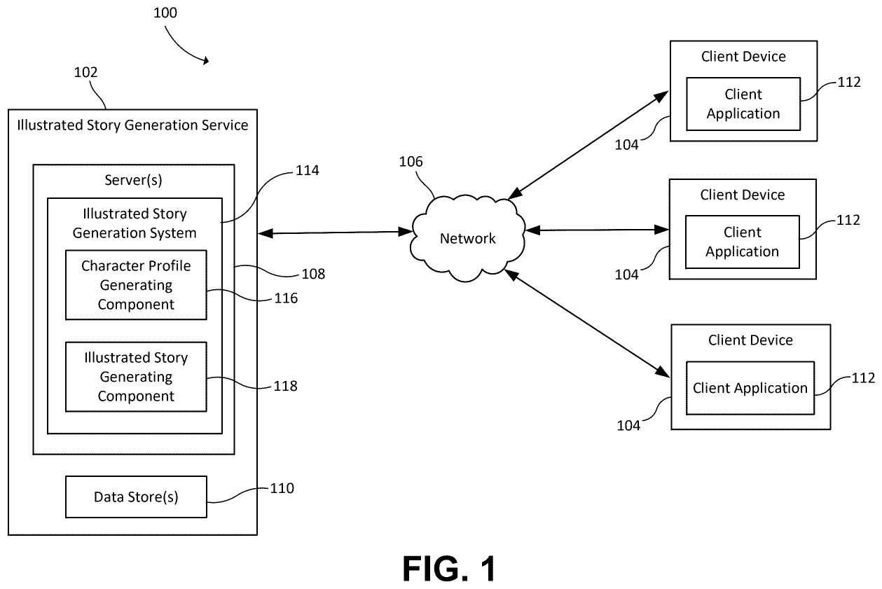

FIG. 1 shows an example computing environment 100 in which aspects of the disclosure may be implemented. The computing environment 100 includes an illustrated story generation service 102 and client devices 104 which communicate with each other via a network 106. The network 106 includes one or more wired, wireless, and/or a combination of wired and wireless networks. In some implementations, the network 106 includes one or more local area networks (LAN), wide area networks (WAN) (e.g., the Internet), public networks, private networks, virtual networks, mesh networks, peer-to-peer networks, and/or other interconnected data paths across which multiple devices may communicate. In some examples, the network 106 is coupled to or includes portions of a telecommunications network for sending data in a variety of different communication protocols. In some implementations, the network 106 includes Bluetooth® communication networks or a cellular communications network for sending and receiving data including via short messaging service (SMS), multimedia messaging service (MMS), hypertext transfer protocol (HTTP), direct data connection, WAP, email, and the like.

The interactive story generation service 102 is implemented as a cloud-based service or set of services. To this end, the interactive story generation service 102 is executed on or includes at least one server 108 which is configured to provide computational and/or storage resources for implementing the interactive story generation service 102. The server 108 is representative of any physical or virtual computing system, device, or collection thereof, such as, a web server, rack server, blade server, virtual machine server, or tower server, as well as any other type of computing system used to implement the interactive story generation service 102. Servers are implemented using any suitable number and type of physical and/or virtual computing resources (e.g., standalone computing devices, blade servers, virtual machines, etc.). Interactive story generation service 102 may also include one or more data stores 110 for storing data, programs, and the like for implementing and managing the interactive story generation service 102. In FIG. 1, one server 108 and one data store 110 are shown, although any suitable number of servers and/or data stores may be utilized.

Client devices 104 enable users to access the services provided by the interactive story generation service 102 via the network 106. Client devices 104 can be any suitable type of computing device, such as personal computers, desktop computers, laptop computers, smart phones, tablets, gaming consoles, smart televisions and the like. Client devices 104 include at least one client application 112 that is configured to interact with the interactive story generation service 102. In various implementations, client application 112 is a dedicated application installed on the client device and programmed to interact with one or more services provided by a cloud infrastructure. In some implementations, client application 112 is an add-on, extension, or the like that can be integrated into other applications to enable interaction with the interactive story generation service 102. In some cases, client application 112 is a general-purpose application, such as a web browser, configured to access services and/or applications over the network 106.

The illustrated story generation service 102 includes an illustrated story generation system 114 for generating illustrated stories and storybooks for users. As discussed below, the system includes interactive storyline adaptation features which enable users to guide character creation and storyline and illustration generation, so stories unfold with consistent and coherent visual storytelling while remaining true to a user's vision. The system includes a character profile generation component 116 that enables personalized character profiles to be generated for inclusion in a story. Users can provide photos of individuals (e.g., full face and full body photos) for the system to use as the basis for generating stylized images (also referred to as profile images) for a character profile. Users can also provide text which defines parameters for character generation. The parameters can specify the style (e.g., cartoon, comic, anime, etc.) in which to generate the character profile image as well character specifics, such as name, age, visible characteristics, personality traits, and the like.

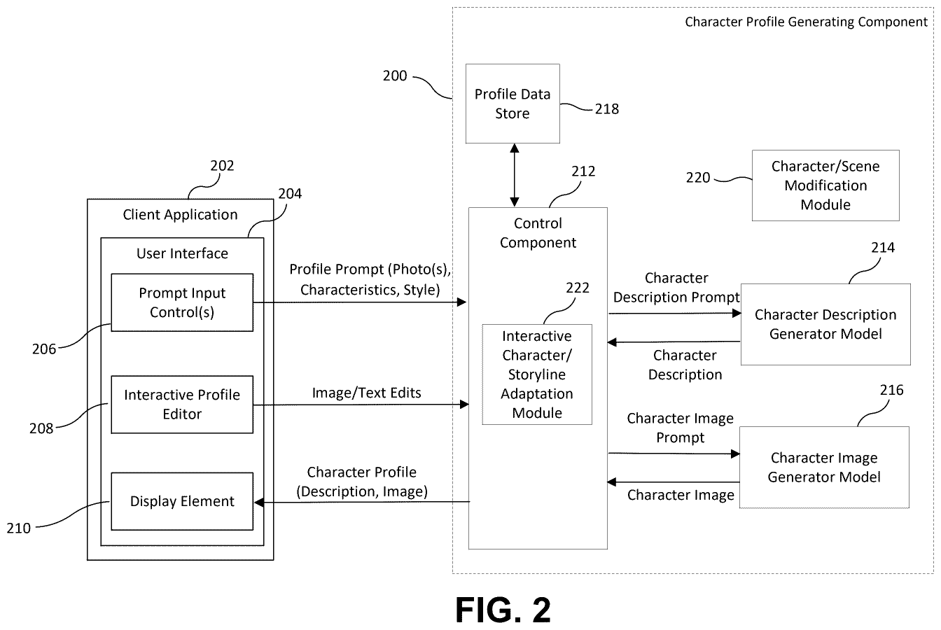

An example implementation of a character profile generating component 200 is shown in FIG. 2. The character profile generating component 200 receives a character profile prompt from a client device 202 which includes one or more photos of an individual to use as the basis for a character and text which defines one or more parameters for the system to use in generating a character profile for the character. Client application 202 displays a user interface 204 having one or more prompt input controls 206, such as text input fields, photo uploading/selecting controls, and the like, for receiving photos and text for a prompt.

The character profile generating component 200 includes a control component 212, a profile description generator model 214, and a profile image generator model 216. The control component 212 receives character profile prompts from the client application 202 and handles the inputs and outputs of the models 214, 216 to coordinate the generation of character profiles which are returned to the client application 202. In particular, the control component 212 receives a character profile prompt from the client application 202 and provides the prompt to the character description generator model 214 as an input. The character description generator model 214 comprises an image-to-text model that has been trained to generate character descriptions which describe individuals depicted in photos. A character description can describe a person to any desired level of detail and include any characteristic or trait which the model 214 has been trained to recognize and describe, such as facial attributes, age, height, build, skin tone, outfit, accessories, etc. Character description may be generated in natural language and may be conditioned on parameters included in the prompt, such as name, age, and the specification of other characteristics or traits for the character. The character description generator model 214 can be implemented using any suitable type and/or combination of generative AI, machine learning models, algorithms, etc. which enable the model to generate character descriptions of individuals depicted in photos. In various implementations, the character description generator model 214 is implemented in one or more Large Language Models (LLMs) or Large Multimodal Models (LMMs), such as GPT-4V.

The character description generated by the character description generator model 214 is returned to the control component 212. The control component 212 then provides the character description as a prompt to a character image generator model 216. The character image generator model 216 comprises a text-to-image model which has been trained to generate a character image based on a character description. Examples of text-to-image models which may be used to implement the character image generator model 216 include DALL-E 3, Musc, Generative Adversarial Networks (GANs), Variational Autoencoders (VAEs), and the like. The prompt to the text-to-image model may include the parameters from the original character profile prompt, such as style, which specify how the character image is to be generated.

The control component 212 receives character images generated by the character image generator model 216 and returns the character image and character description used as the basis for generating the character image to the client device 202 as a character profile. At the client application 202, the character description and character image for a character profile are displayed in a display element 210 of the user interface 204. The user interface 204 provides controls which enable a user to accept the character profile. If the character profile is accepted, the control component 212 stores the character profile in a profile data store 218 so it can be retrieved and used by the system in generating stories.

The character profile generating component 200 includes various interactive editing and/or modification components which enable interactive and user-guided character creation. For example, the client application 202 includes an interactive profile editor 208 to facilitate character edits and modifications to facilitate the generation of character profiles with desired visual appearances, characteristics, outfits, accessories, and the like. In various implementations, the user interface 204 includes a user interface control which causes the client application to enter an editing mode which enables the current character profile to be edited by using the interactive profile editor 208. In various implementations, the control component 212 includes an interactive character/storyline adaptation module 222 which can work alone or in conjunction with the interactive profile editor 208 to create an interactive system where user inputs can steer a story's direction, and that enable the generation of dynamically generated images that align with an evolving plot. To implement this feature, text-to-image models may be used to interpret narrative context and user suggestions. The interactive character/storyline adaptation module 222 enables users to modify the storyline starting from a specific page with the new story text and corresponding images generated based on user preferences to steer a story in a desired direction, as explained in more details below.

The interactive profile editor 208 and/or the interactive character/storyline adaptation module 222 may enable elements of an images to be selected for modification, e.g., by clicking on an element in the image. Once an element has been selected, the editor 208 and/or the module 222 may enable identification of the selected element so that appropriate modification options may be presented to the user. Examples of elements that may selected include substantially any distinguishable feature in an image, including character features, such as hair, face, eyes, shirt, pants, accessories, etc. and background features, such as floor, walls, windows, decorations, sky, etc. Once a selected element has been identified, modifications which are appropriate for the selected element may be presented in the user interface of the application. For example, if a user selects the hair of a character in a profile image to modify, a menu which facilitates hair modifications, such as changes to hair color, style, length, texture, and the like, can be presented to the user. Similarly, if a user selects a character's shirt for modification, a menu which facilitates shirt modifications, such as color, type, size, fit, etc., can be presented to the user.

Image modifications may be implemented in a number of ways. As one example, selected modifications may be returned to the control component 212 which in turn generates a prompt for the character image generator model 216 that instructs the model to generate a modified character image that includes the selected modification. For example, if a user selects a modification to hair color of a character in a character image, the control component 212 can generate a prompt that instructs the character image generator model 216 to generate a modified character image based on the current character image and the selected modification. The control component 212 receives the modified character image and provides the modified image to the client device where it is displayed by the display element 210. The modified character image can be accepted by the user or modified again using the interactive profile editor 208. A character image may undergo any number of editing cycles before acceptance by a user. Once accepted, the finalized character profile is stored in the profile data store 218.

In various implementations, image modifications may be implemented using separate components, such as the character/scene modification module 220. The character/scene modification module 220 enables various modifications to character and scene images, such as stylized character representations, the generation of character animations which can be integrated into illustrations, the ability to change/alter character clothing, hairstyles, and the like, and the ability to generate audio content and mouth animations to have characters talk or generate narration for a story. The character/scene modification module 220 may provide AI systems, machine learning algorithms, and the like to implement character and scene modification features which can be called upon by the interactive profile editor 208 and the interactive character/storyline adaptation module 222 to perform the functions mentioned above, such as stylized character representations, character animation, appearance modifications (e.g., outfit changes, hairstyle changes, and the like) and voice content generation and integration. Stylized character representations may be implemented using style transfer algorithms to adapt characters into diverse artistic forms while retaining their core visual identity. Models, such as Stable Diffusion XL model, can be used to generate specific art styles for high-fidelity results and enable the platform to handle a diverse range of styles such as watercolor, Claymation, origami, art deco, pixel art, hyper surreal, low poly, steam punk, macro view, topline, etc. Stable diffusion models may be used to generate a wide array of character poses and facial expressions to enhance emotive storytelling.

Returning to FIG. 1, the system 114 also includes an illustrated story generating component 118 for generating illustrated stories or storybooks based on narrative prompts received from users of the illustrated story generating system 114. A narrative prompt includes text which defines one or more story parameters, such as number of pages, plot points, character profiles, story beginning, story ending, and the like, as well as any underlying messages or lessons to be gleaned from the story. The illustrated story generating component 118 includes story and image generating AI which are trained to generate story text and illustrations for a story based on the narrative prompt.

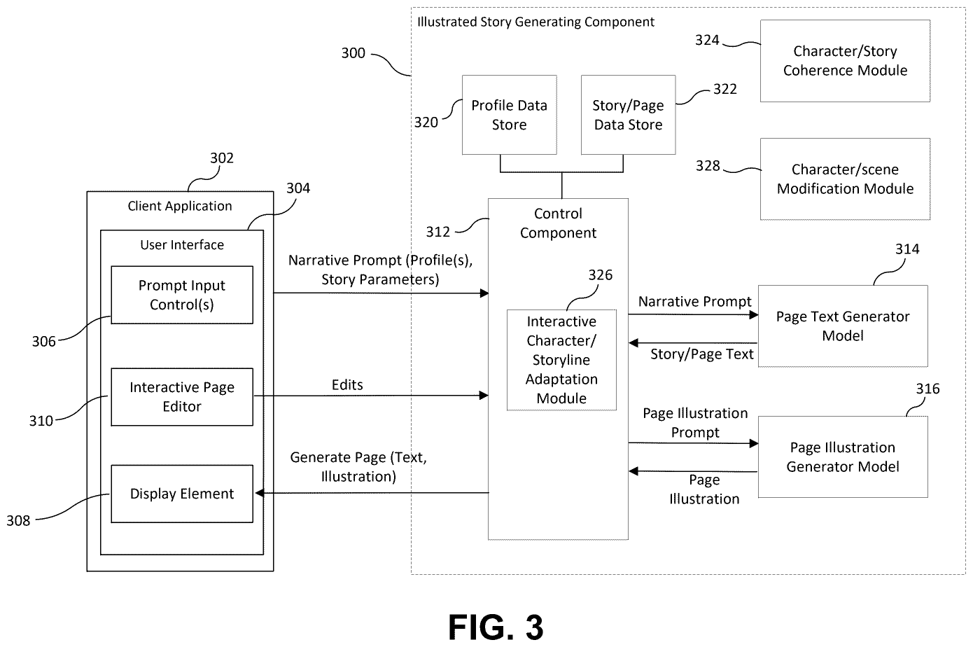

An example implementation of an illustrated story generating component 300 is shown in FIG. 3. The illustrated story generating component 300 receives narrative prompts from the client application 302. The client application 302 includes a user interface 304 having one or more prompt input controls 306, such as text input fields, for receiving the narrative prompt. The illustrated story generating component 300 includes a control component 312 which receives narrative prompts from the client application 302 and handles the inputs and outputs of story generating AI to coordinate the generation of text and illustrations for a story. To facilitate user interaction, engagement, and user-guided storytelling, the illustrated story generating component 300 is configured to generate story text in a page-by-page manner. To this end, the component 300 includes a page text generator model 314. The control component 312 provides the narrative prompt to the page text generator model 314 as an input. In various implementations, the control component first retrieves the character profile(s) associated with the narrative prompt from the profile data store 320 and includes them in the narrative prompt before providing the prompt to the page text generator model 314. The page text generator model 314 comprises a text generation model that has been trained to generate narrative text for a story involving the specified character(s) and that takes into consideration the characteristics of the character(s) and the story parameters to generate the story text. Any suitable type or combination of text generating model can be used to generate story text. In some implementations, the page text generator model 314 is implemented as a Large Language Model (LLM). Examples of LLMs that may be used for story generation tasks include GPT-3, GPT-4, ChatGPT, and the like.

Story text can be generated in a page-by-page manner using a number of suitable methods. For example, in some implementations, the page text generator model 314 is trained to generate story text one page at a time. The page text generator model 314 may be trained to select a small number of plot points (e.g., one, two, or a few) to describe in connection with a page. For example, if a user requests a story about a child's first day at school, the plot points that can be used as the basis for different pages of the story include the things that happened before the child went to school, the things that happened while the child was at school, and the things that happened after school. In other implementations, the page text generator model generates the entire text for a story which is then divided into pages by the control component 312 (or any other suitable component). In any event, the control component 312 generates a page illustration prompt for each story page that includes the page text for the page and the character profiles (including character descriptions and character images) which are associated with the page.

A page illustration prompt is provided to the page illustration generator model 316, and the page illustration generator model 316 generates a page illustration based on the first page illustration prompt. In various implementations, the page illustration generator model 316 comprises a text-to-image model which has been trained to generate illustrations conditioned on the narrative text and character profiles. Examples of image generating models which may be used to implement the page illustration generator model 316 include DALL-E 3, Muse, Generative Adversarial Networks (GANs), Variational Autoencoders (VAEs), and the like.

The control component 312 receives the page illustration from the page illustration generator model 316 and provides the page illustration and associated page text to the client application 302 as a generated story page. At the client application 302, the generated story page is displayed in the display clement 308. A user can accept the generated page or decide to edit the page (e.g., by interacting with appropriate interface controls in the user interface). If the page is accepted, the control component 312 stores the generated page (text and illustration) in a story/page data store 322 in association with the story being generated. Each page illustration is generated and finalized before the next page illustration is generated. This enables users to adapt and steer storylines so that stories are generated in the manner intended by the user. Once a page has been accepted by a user and stored in the story/page data store 322, the control component can initiate the generation of the next story page, e.g., by providing a prompt including the page text for the next page of the story and character profiles associated with the next page to the page illustration generator model 316. Page illustrations are generated in the manner described above for each page of the story until the text and illustration for the last page of the story are accepted and stored in association with the story in the story/page data store 322.

The illustrated story generating component 300 includes various interactive editing and/or modification components which enable interactive and user-guided storyline creation. For example, the client application 302 includes an interactive page editor 310 which enables page text and illustrations to be edited in substantially the same manner as described above in connection with the profile generating component 200. For example, with the selection of the appropriate controls in the user interface 304, a user can cause the client application to enter into an editing mode which enables a page to be edited by the interactive page editor 310. In the editing mode, the user can select image elements to modify, e.g., by clicking on an element in the image. In various implementations, the control component 312 includes an interactive character/storyline adaptation module 326 which can work alone or in conjunction with the interactive page editor 310 to create an interactive system where user inputs can steer a story's direction, and that enable the generation of dynamically generated images that align with an evolving plot. To implement this feature, text-to-image models may be used to interpret narrative context and user suggestions. The interactive character/storyline adaptation module 326 enables users to modify the storyline starting from a specific page with the new story text and corresponding images generated based on user preferences to steer a story in a desired direction, as explained in more details below.

The interactive page editor 310 and/or the interactive character/storyline adaption module 326 may enable elements of an images to be selected for modification, e.g., by clicking on an element in the image. Once an element has been selected, the editor 310 and/or the module 326 may enable identification of the selected element so that appropriate modification options may be presented to the user, as described above. Image modifications may be implemented in a number of ways. As one example, selected modifications may be returned to the control component 312 which can in turn generate a prompt for the page illustration generator model 316 that instructs the model to generate a modified page illustration that includes the selected modification. The control component 312 receives the modified page illustration and returns the modified illustration to the client device 302 where it is displayed in the display element 308. The modified page illustration can be accepted by the user or modified again using the interactive profile editor 208 and/or the interactive adaptation module 326. A page illustration may undergo any number of editing cycles before acceptance by a user. Once accepted, the finalized page is stored in the story/page data store 322.

In various implementations, page illustration modifications may be performed by separate components, such as the character/scene modification module 328. The character/scene modification module 328 enables various modifications to character and scene images, such as stylized character representations, the generation of character animations which can be integrated into illustrations, the ability to change/alter character clothing, hairstyles, and the like, and the ability to generate audio content and mouth animations to have characters talk or generate narration for a story. The character/scene modification module 328 may provide AI systems, machine learning algorithms, and the like to implement character and scene modification features which can be called upon by the interactive page editor 310 and the interactive character/storyline adaptation module 326 to perform the functions mentioned above, such as stylized character representations, character animation, appearance modifications (e.g., outfit changes, hairstyle changes, and the like) and voice content generation and integration.

The illustrated story generating component 300 may include a number of other components or modules which facilitate visual identity consistency, character development over time, stylized character representation, multiple character interactions, pose and facial expression generation, creative and diverse story generation, and interactive storyline adaptation. For example, in the implementation of FIG. 3, the illustrated story generating component 300 includes a story/character coherence module 324 which monitors character and storyline representations to ensure representations are consistent and coherent across all illustrations of a story. The coherence module may leverage deep learning models, such as a neural network trained on visual pattern recognition, to analyze character design to ensure visual traits like hair color, attire, and unique features are consistent and coherent across all pages of a story. The module may employ generative models with temporal awareness to implement believable changes in characters over time that reflect the narrative of the story. Relationship modeling and character interaction dynamics may be incorporated into scene generation using reinforcement learning to guide character behavior and interactions based on their relationships and personalities.

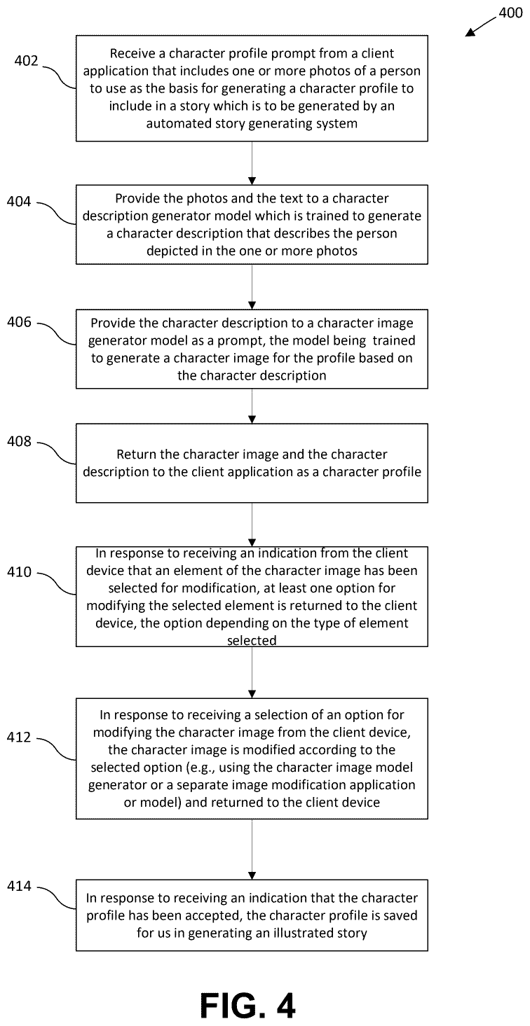

FIG. 4 depicts a flowchart of an example method 400 of generating character profiles for an illustrated story generating system to use in generating an illustrated story. The method begins with receiving a character profile prompt from a client application that includes one or more photos of a person to use as the basis for generating a character profile to include in a story which is to be generated by an automated story generating system (block 402). The prompt also includes text which defines one or more parameters, such as the image style, for the system to use in generating the character profile. The photos and the text are provided to a character description generator model which is trained to generate a character description that describes the person depicted in the one or more photos (block 404). The character description is then provided to a character image generator model which is trained to generate a character image for the profile based on the character description (block 406). The character image may be generated based in part on parameters which may be specified in the prompt text. For example, the prompt text may specify an image style (e.g., cartoon, comic, anime, etc.) in which to generate the image. The character image and character description are then returned to the client application and presented as a character profile (block 408). In response to receiving an indication from the client device that an element of the character image has been selected for modification, at least one option for modifying the selected element is returned to the client device, the option depending on the type of element selected (block 410). In response to receiving a selection of an option for modifying the character image from the client device, the character image is modified according to the selected option (e.g., using the character image model generator or a separate image modification application or model) and returned to the client device (block 412). In response to receiving an indication that the character profile has been accepted, the character profile is saved for us in generating an illustrated story (block 414).

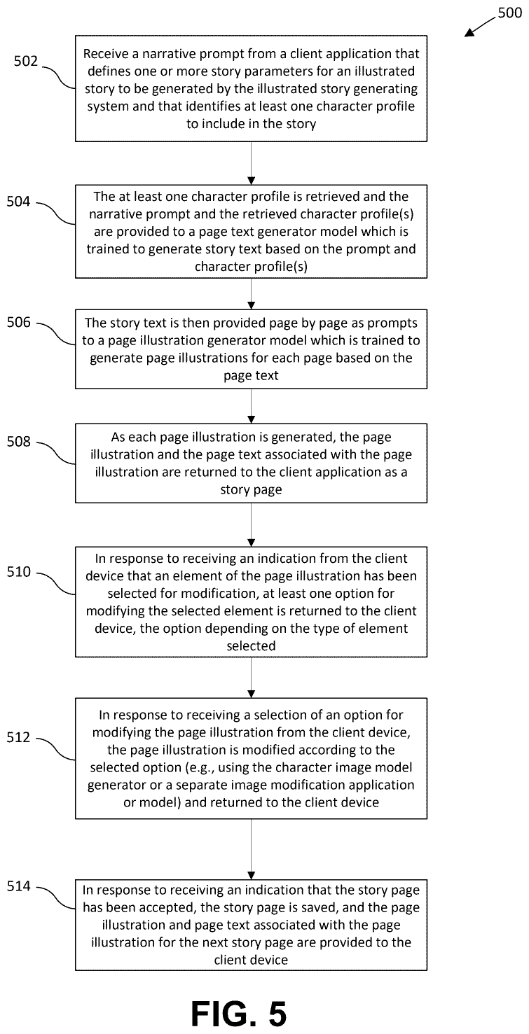

FIG. 5 shows a flowchart of an example method 500 of generating a character profile to use in generating an illustrated story using an illustrated story generating system in accordance with this disclosure. The method begins with receiving narrative prompt from a client application that defines one or more story parameters for an illustrated story to be generated by the illustrated story generating system and that identifies at least one character profile to include in the story (block 502). The at least one character profile is retrieved, and the narrative prompt and the retrieved character profile(s) are provided to a page text generator model which is trained to generate story text based on the prompt and character profile(s) (block 504). The story text is then provided page by page as prompts to a page illustration generator model which is trained to generate page illustrations for each page based on the page text (block 506). As each page illustration is generated, the page illustration and the page text associated with the page illustration are returned to the client application as a story page (block 508). In response to receiving an indication from the client device that an element of the page illustration has been selected for modification, at least one option for modifying the selected clement is returned to the client device, the option depending on the type of element selected (block 510) In response to receiving a selection of an option for modifying the page illustration from the client device, the page illustration is modified according to the selected option (e.g., using the character image model generator or a separate image modification application or model) and returned to the client device (block 512). In response to receiving an indication that the story page has been accepted, the story page is saved, and the page illustration and page text associated with the page illustration for the next story page are provided to the client device (block 514).

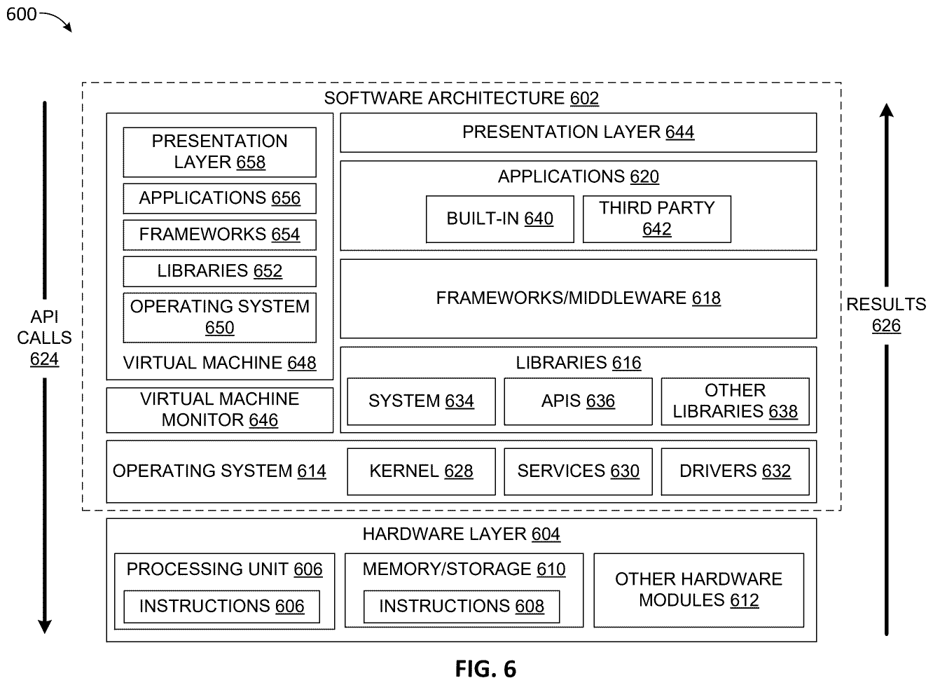

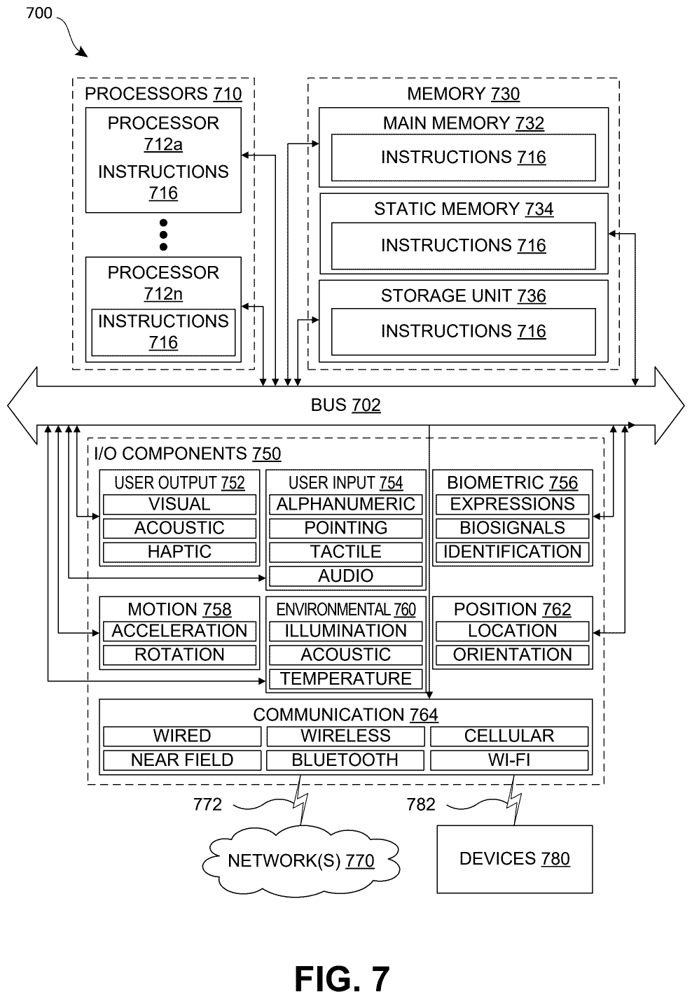

FIG. 6 is a block diagram 600 illustrating an example software architecture 602, various portions of which may be used in conjunction with various hardware architectures herein described, which may implement any of the above-described features. FIG. 6 is a non-limiting example of a software architecture, and it will be appreciated that many other architectures may be implemented to facilitate the functionality described herein. The software architecture 602 may execute on hardware such as a machine 700 of FIG. 7 that includes, among other things, processors 710, memory 730, and input/output (I/O) components 750. A representative hardware layer 604 is illustrated and can represent, for example, the machine 700 of FIG. 7. The representative hardware layer 604 includes a processing unit 606 and associated executable instructions 608. The executable instructions 608 represent executable instructions of the software architecture 602, including implementation of the methods, modules and so forth described herein. The hardware layer 604 also includes a memory/storage 610, which also includes the executable instructions 608 and accompanying data. The hardware layer 604 may also include other hardware modules 612. Instructions 608 held by processing unit 606 may be portions of instructions 608 held by the memory/storage 610.

The example software architecture 602 may be conceptualized as layers, each providing various functionality. For example, the software architecture 602 may include layers and components such as an operating system (OS) 614, libraries 616, frameworks 618, applications 620, and a presentation layer 644. Operationally, the applications 620 and/or other components within the layers may invoke API calls 624 to other layers and receive corresponding results 626. The layers illustrated are representative in nature and other software architectures may include additional or different layers. For example, some mobile or special purpose operating systems may not provide the frameworks/middleware 618.

The OS 614 may manage hardware resources and provide common services. The OS 614 may include, for example, a kernel 628, services 630, and drivers 632. The kernel 628 may act as an abstraction layer between the hardware layer 604 and other software layers. For example, the kernel 628 may be responsible for memory management, processor management (for example, scheduling), component management, networking, security settings, and so on. The services 630 may provide other common services for the other software layers. The drivers 632 may be responsible for controlling or interfacing with the underlying hardware layer 604. For instance, the drivers 632 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 616 may provide a common infrastructure that may be used by the applications 620 and/or other components and/or layers. The libraries 616 typically provide functionality for use by other software modules to perform tasks, rather than rather than interacting directly with the OS 614. The libraries 616 may include system libraries 634 (for example, C standard library) that may provide functions such as memory allocation, string manipulation, file operations. In addition, the libraries 616 may include API libraries 636 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 616 may also include a wide variety of other libraries 638 to provide many functions for applications 620 and other software modules.

The frameworks 618 (also sometimes referred to as middleware) provide a higher-level common infrastructure that may be used by the applications 620 and/or other software modules. For example, the frameworks 618 may provide various graphic user interface (GUI) functions, high-level resource management, or high-level location services. The frameworks 618 may provide a broad spectrum of other APIs for applications 620 and/or other software modules.

The applications 620 include built-in applications 640 and/or third-party applications 642. Examples of built-in applications 640 may include, but are not limited to, a contacts application, a browser application, a location application, a media application, a messaging application, and/or a game application. Third-party applications 642 may include any applications developed by an entity other than the vendor of the particular platform. The applications 620 may use functions available via OS 614, libraries 616, frameworks 618, and presentation layer 644 to create user interfaces to interact with users.

Some software architectures use virtual machines, as illustrated by a virtual machine 648. The virtual machine 648 provides an execution environment where applications/modules can execute as if they were executing on a hardware machine (such as the machine 700 of FIG. 7, for example). The virtual machine 648 may be hosted by a host OS (for example, OS 614) or hypervisor, and may have a virtual machine monitor 646 which manages operation of the virtual machine 648 and interoperation with the host operating system. A software architecture, which may be different from software architecture 602 outside of the virtual machine, executes within the virtual machine 648 such as an OS 650, libraries 652, frameworks 654, applications 656, and/or a presentation layer 658.

FIG. 7 is a block diagram illustrating components of an example machine 700 configured to read instructions from a machine-readable medium (for example, a machine-readable storage medium) and perform any of the features described herein. The example machine 700 is in a form of a computer system, within which instructions 716 (for example, in the form of software components) for causing the machine 700 to perform any of the features described herein may be executed. As such, the instructions 716 may be used to implement modules or components described herein. The instructions 716 cause unprogrammed and/or unconfigured machine 700 to operate as a particular machine configured to carry out the described features. The machine 700 may be configured to operate as a standalone device or may be coupled (for example, networked) to other machines. In a networked deployment, the machine 700 may operate in the capacity of a server machine or a client machine in a server-client network environment, or as a node in a peer-to-peer or distributed network environment. Machine 700 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 700 is illustrated, the term “machine” includes a collection of machines that individually or jointly execute the instructions 716.

The machine 700 may include processors 710, memory 730, and I/O components 750, which may be communicatively coupled via, for example, a bus 702. The bus 702 may include multiple buses coupling various elements of machine 700 via various bus technologies and protocols. In an example, the processors 710 (including, for example, a central processing unit (CPU), a graphics processing unit (GPU), a digital signal processor (DSP), an ASIC, or a suitable combination thereof) may include one or more processors 712a to 712n that may execute the instructions 716 and process data. In some examples, one or more processors 710 may execute instructions provided or identified by one or more other processors 710. The term “processor” includes a multi-core processor including cores that may execute instructions contemporaneously. Although FIG. 7 shows multiple processors, the machine 700 may include a single processor with a single core, a single processor with multiple cores (for example, a multi-core processor), multiple processors each with a single core, multiple processors each with multiple cores, or any combination thereof. In some examples, the machine 700 may include multiple processors distributed among multiple machines.

The memory/storage 730 may include a main memory 732, a static memory 734, or other memory, and a storage unit 736, both accessible to the processors 710 such as via the bus 702. The storage unit 736 and memory 732, 734 store instructions 716 embodying any one or more of the functions described herein. The memory/storage 730 may also store temporary, intermediate, and/or long-term data for processors 710. The instructions 716 may also reside, completely or partially, within the memory 732, 734, within the storage unit 736, within at least one of the processors 710 (for example, within a command buffer or cache memory), within memory at least one of I/O components 750, or any suitable combination thereof, during execution thereof. Accordingly, the memory 732, 734, the storage unit 736, memory in processors 710, and memory in I/O components 750 are examples of machine-readable media.

As used herein, “machine-readable medium” refers to a device able to temporarily or permanently store instructions and data that cause machine 700 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 716) for execution by a machine 700 such that the instructions, when executed by one or more processors 710 of the machine 700, cause the machine 700 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 750 may include a wide variety of hardware components adapted to receive input, provide output, produce output, transmit information, exchange information, capture measurements, and so on. The specific I/O components 750 included in a particular machine will depend on the type and/or function of the machine. For example, mobile devices such as mobile phones may include a touch input device, whereas a headless server or IoT device may not include such a touch input device. The particular examples of I/O components illustrated in FIG. 7 are in no way limiting, and other types of components may be included in machine 700. The grouping of I/O components 750 are merely for simplifying this discussion, and the grouping is in no way limiting. In various examples, the I/O components 750 may include user output components 752 and user input components 754. User output components 752 may include, for example, display components for displaying information (for example, a liquid crystal display (LCD) or a projector), acoustic components (for example, speakers), haptic components (for example, a vibratory motor or force-feedback device), and/or other signal generators. User input components 754 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 750 may include biometric components 756, motion components 758, environmental components 760, and/or position components 762, among a wide array of other physical sensor components. The biometric components 756 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 758 may include, for example, acceleration sensors (for example, an accelerometer) and rotation sensors (for example, a gyroscope). The environmental components 760 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 762 may include, for example, location sensors (for example, a Global Position System (GPS) receiver), altitude sensors (for example, an air pressure sensor from which altitude may be derived), and/or orientation sensors (for example, magnetometers).

The I/O components 750 may include communication components 764, implementing a wide variety of technologies operable to couple the machine 700 to network(s) 770 and/or device(s) 780 via respective communicative couplings 772 and 782. The communication components 764 may include one or more network interface components or other suitable devices to interface with the network(s) 770. The communication components 764 may include, for example, components adapted to provide wired communication, wireless communication, cellular communication, Near Field Communication (NFC), Bluetooth communication, Wi-Fi, and/or communication via other modalities. The device(s) 780 may include other machines or various peripheral devices (for example, coupled via USB).

In some examples, the communication components 764 may detect identifiers or include components adapted to detect identifiers. For example, the communication components 764 may include Radio Frequency Identification (RFID) tag readers, NFC detectors, optical sensors (for example, one-or multi-dimensional bar codes, or other optical codes), and/or acoustic detectors (for example, microphones to identify tagged audio signals). In some examples, location information may be determined based on information from the communication components 764, such as, but not limited to, geo-location via Internet Protocol (IP) address, location via Wi-Fi, cellular, NFC, Bluetooth, or other wireless station identification and/or signal triangulation.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element. Furthermore, subsequent limitations referring back to “said element” or “the element” performing certain functions signifies that “said element” or “the element” alone or in combination with additional identical elements in the process, method, article or apparatus are capable of performing all of the recited functions.

What is claimed is:

1. A data processing system comprising:
a processor; and
a memory in communication with the processor, the memory comprising executable instructions that, when executed by the processor alone or in combination with other processors, cause the data processing system to perform functions of:
receiving a narrative prompt from a client application that defines one or more story parameters for an illustrated story to be generated by an illustrated story generating system and that identifies at least one character profile to include in the story;
retrieving the at least one character profile and providing the narrative prompt and the at least one character profile to a story text generator model trained to generate story text based on the narrative prompt and the at least one character profile, the story text including a plurality of pages, each of the pages having page text;
receiving the story text from the story text generator model and providing each page of the story text as a prompt to a page illustration generator model, the page illustration generator model being trained to generate a page illustration for each page based on the story text for the page; and
as each page illustration is generated, saving the page illustration and the page text associated with the page illustration as a story page of an illustrated story file.

2. The data processing system of claim 1, wherein the functions further comprise:
before storing each story page, returning the page illustration and the page text associated with the story page to the client application;
in response to receiving an indication from the client application that an element of the story page has been selected for modification, returning at least one option for modifying the selected element to the client application, the at least one option depending on a type of element selected;
in response to receiving a selection of an option for modifying the element of the story page, modifying the element of the story page according to the selected option and returning the modified story page to the client application; and
in response to receiving an indication that the modified story page has been accepted, saving the modified story page in association with the illustrated story.

3. The data processing system of claim 2, wherein the functions further comprise:
receiving an indication from the client application that the page text associated with the story page has been selected for modification and modification information defining how the page text should be modified; and
generating a prompt for the story text generating model that includes the page text and the modification information, wherein the story text generating model generates new story text starting from the story page which has been selected for modification, the new story text replacing any remaining story text.

4. The data processing system of claim 2, wherein the functions further comprise:
receiving an indication from the client application that a visual element of the page illustration for the story page has been selected for modification information defining how the visual element should be modified; and
providing the page illustration to the page illustration generator model along with instructions for modifying the page illustration based on the modification information.

5. The data processing system of claim 2, wherein the functions further comprise:
receiving a request to modify a page illustration by animating at least one visual element of the page illustration, the request defining how to animate the at least one visual element; and
providing the page illustration to an animation model to animate the at least one visual element according to the request.

6. The data processing system of claim 1, wherein the functions further comprise:
monitoring a physical appearance of each character from one page illustration to another to ensure consistency of appearance, personality, and emotion of each character across page illustrations for the illustrated story.

7. The data processing system of claim 1, wherein the functions further comprise:
monitoring a physical appearance of each character from one page illustration to another with respect to a storyline of the illustrated story to ensure that the physical appearance of each character accurately reflects character development in the illustrated story.

8. The data processing system of claim 1, wherein the functions further comprise:
receiving a character profile prompt from the client application which includes one or more photos of an individual to use as a basis for a character profile and text which defines one or more parameters to use in generating the character profile;
providing the one or more photos and the text to a character description generator model, the character description generator model including an image-to-text model that has been trained to generate a character description which describes the individual depicted in the one or more photos conditioned on the text;
providing the character description in a prompt to a character image generator model, the character image generator model including a text-to-image model that has been trained to generate a character image based on the character description; and
saving the character description and the character image as a new character profile for the illustrated story generating system.

9. A method of generating an illustrated story using an illustrated story generating system, the method comprising:
receiving a narrative prompt from a client application that defines one or more story parameters for an illustrated story to be generated by the illustrated story generating system and that identifies at least one character profile to include in the story;
retrieving the at least one character profile and providing the narrative prompt and the at least one character profile to a story text generator model trained to generate story text based on the narrative prompt and the at least one character profile, the story text including a plurality of pages, each of the pages having page text;
receiving the story text from the story text generator model and providing each page of the story text as a prompt to a page illustration generator model, the page illustration generator model being trained to generate a page illustration for each page based on the story text for the page; and
as each page illustration is generated, saving the page illustration and the page text associated with the page illustration as a story page of an illustrated story file.

10. The method of claim 9, further comprising:
before saving each story page, returning the page illustration and the page text associated with the story page to the client application;
in response to receiving an indication from the client application that an element of the story page has been selected for modification, returning at least one option for modifying the selected element to the client application, the at least one option depending on a type of element selected;
in response to receiving a selection of an option for modifying the element of the story page, modifying the element of the story page according to the selected option and returning the modified story page to the client application; and
in response to receiving an indication that the modified story page has been accepted, saving the modified story page in association with the illustrated story.

11. The method of claim 10, further comprising:
receiving an indication from the client application that the page text associated with the story page has been selected for modification and modification information defining how the page text should be modified; and
generating a prompt for the story text generating model that includes the page text and the modification information, wherein the story text generating model generates new story text starting from the story page which has been selected for modification, the new story text replacing any remaining story text.

12. The method of claim 10, further comprising:
receiving an indication from the client application that a visual element of the page illustration for the story page has been selected for modification information defining how the visual element should be modified; and
providing the page illustration to the page illustration generator model along with instructions for modifying the page illustration based on the modification information.

13. The method of claim 10, further comprising:
receiving a request to modify a page illustration by animating at least one visual element of the page illustration, the request defining how to animate the at least one visual element; and
providing the page illustration to an animation model to animate the at least one visual element according to the request.

14. The method of claim 9, further comprising:
monitoring a physical appearance of each character from one page illustration to another to ensure consistency of appearance, personality, and emotion of each character across page illustrations for the illustrated story.

15. The method of claim 9, further comprising:
monitoring a physical appearance of each character from one page illustration to another with respect to a storyline of the illustrated story to ensure that the physical appearance of each character accurately reflects character development in the illustrated story.

16. The method of claim 9, further comprising:
receiving a character profile prompt from the client application which includes one or more photos of an individual to use as a basis for a character profile and text which defines one or more parameters to use in generating the character profile;
providing the one or more photos and the text to a character description generator model, the character description generator model including an image-to-text model that has been trained to generate a character description which describes the individual depicted in the one or more photos conditioned on the text;
providing the character description in a prompt to a character image generator model, the character image generator model including a text-to-image model that has been trained to generate a character image based on the character description; and
saving the character description and the character image as a new character profile for the illustrated story generating system.

17. A non-transitory computer readable medium on which are stored instructions that, when executed, cause a programmable device to perform functions of:
receiving a narrative prompt from a client application that defines one or more story parameters for an illustrated story to be generated by an illustrated story generating system and that identifies at least one character profile to include in the story;
retrieving the at least one character profile and providing the narrative prompt and the at least one character profile to a story text generator model trained to generate story text based on the narrative prompt and the at least one character profile, the story text including a plurality of pages, each of the pages having page text;
receiving the story text from the story text generator model and providing each page of the story text as a prompt to a page illustration generator model, the page illustration generator model being trained to generate a page illustration for each page based on the story text for the page; and
as each page illustration is generated, saving the page illustration and the page text associated with the page illustration as a story page of an illustrated story file.

18. The non-transitory computer readable medium of claim 17, wherein the functions further comprise:
before saving each story page, returning the page illustration and the page text associated with the story page to the client application;
in response to receiving an indication from the client application that an element of the story page has been selected for modification, returning at least one option for modifying the selected element to the client application, the at least one option depending on a type of element selected;
in response to receiving a selection of an option for modifying the element of the story page, modifying the element of the story page according to the selected option and returning the modified story page to the client application; and
in response to receiving an indication that the modified story page has been accepted, saving the modified story page in association with the illustrated story.

19. The non-transitory computer readable medium of claim 17, wherein the functions further comprise:
monitoring a physical appearance of each character from one page illustration to another to ensure consistency of appearance, personality, emotion, and character development of each character across page illustrations for the illustrated story.

20. The non-transitory computer readable medium of claim 17, wherein the functions further comprise:
receiving a character profile prompt from the client application which includes one or more photos of an individual to use as a basis for a character profile and text which defines one or more parameters to use in generating the character profile;
providing the one or more photos and the text to a character description generator model, the character description generator model including an image-to-text model that has been trained to generate a character description which describes the individual depicted in the one or more photos conditioned on the text;
providing the character description in a prompt to a character image generator model, the character image generator model including a text-to-image model that has been trained to generate a character image based on the character description; and
saving the character description and the character image as a new character profile for the illustrated story generating system.
